(19) United States
(12) Patent Application Publication
(10) Pub. No.: US 2025/0133193 A1
(43) Pub. Date: Apr. 24, 2025

(54) IMAGE PROJECTION APPARATUS, IMAGE PROJECTION METHOD, AND NON-TRANSITORY RECORDING MEDIUM

(71) Applicant: Osamu SATO, Kanagawa (JP)

(72) Inventor: Osamu SATO, Kanagawa (JP)

(21) Appl. No.: 18/894,208

(22) Filed: Sep. 24, 2024

(30) Foreign Application Priority Data
Oct. 20, 2023 (JP) 2023-181091

(51) Int. Cl. H04N 9/31; G03B 21/20; G06T 7/90

(52) U.S. Cl. CPC H04N 9/3182; G06T 7/90; H04N 9/3194; G03B 21/204; G06T 2207/10024; H04N 9/3152

(57) ABSTRACT

An image projection apparatus includes a light source to emit light; an imager to generate an image with the light from the light source; a projection optical system to project the image generated by the imager to a projection surface; and circuitry. The circuitry is configured to: acquire image data of the image projected onto the projection surface; classify a pattern of the image indicated by the image data into one of multiple patterns; detect whether the one of multiple patterns has been switched from the one of multiple patterns classified previously; and switch a gamma curve to be applied to the image data, to a gamma curve corresponding to the one of multiple patterns in response to a detection of switching of the one of multiple patterns.

### CROSS-REFERENCE TO RELATED APPLICATIONS

This patent application is based on and claims priority pursuant to 35 U.S.C. § 119(a) to Japanese Patent Application No. 2023-181091, filed on Oct. 20, 2023, in the Japan Patent Office, the entire disclosure of which is hereby incorporated by reference herein.

### BACKGROUND

### Technical Field

The present disclosure relates to an image projection apparatus, an image projection method, and a non-transitory recording medium.

### Related Art

A lens of a projection optical system mounted on an image projection apparatus (projector) expands or contracts depending on the temperature to a certain degree. Such expansion or contraction of the lens of the projection optical system is noticeable in an optical system employing a reflecting mirror for decreasing the focal length. That is, when a bright image is projected and displayed, the intensity of transmitted light increases, and hence the temperature rises and a lens included in the projection optical system (when a reflecting mirror is employed, the lens and the reflecting mirror) expands. In contrast, when a dark image is projected and displayed, the intensity of transmitted light decreases, and hence a lens (when a reflecting mirror is employed, the lens and the reflecting mirror) of the projection optical system less expands, and the lens seems to contract as compared to the expanding state. When a lens expands or contracts due to a change in temperature, the focal length of the lens varies. This phenomenon is referred to as a temperature drift (hereinafter, simply referred to as a drift). The drift causes a variation in the focal position of the lens, and hence the variation is recognized as defocusing of an image projected on a screen.

The drift may be expected in the design of the optical system; however, it is difficult to completely eliminate the drift in the range of use of the lens. An optical designer makes a design to minimize the drift as much as possible; however, to reduce the drift to a completely negligible level, the lens configuration may be very expensive, and the lens may be unsuitable for a lens of a projection optical system of a general-purpose projector. Thus, the actual situation is that a lens is designed to allow a certain degree of drift. Moreover, simple adjustment in the manufacturing process is desirable, and hence simple design of the lens system is also desirable.

### SUMMARY

According to an embodiment of the present disclosure, an image projection apparatus includes a light source to emit light; an imager to generate an image with the light from the light source; a projection optical system to project the image generated by the imager to a projection surface; and circuitry. The circuitry is configured to: acquire image data of the image projected onto the projection surface; classify a pattern of the image indicated by the image data into one of multiple patterns; detect whether the one of multiple patterns has been switched from the one of multiple patterns classified previously; and switch a gamma curve to be applied to the image data, to a gamma curve corresponding to the one of multiple patterns in response to a detection of switching of the one of multiple patterns.

According to an embodiment of the present disclosure, an image projection method for projecting an image from a projection optical system, includes emitting light; generating an image with the light from the light source; projecting the image generated, to a projection surface; and acquiring image data of the image projected onto the projection surface; classifying a pattern of the image indicated by the image data into one of multiple patterns; detecting whether the one of multiple patterns has been switched from the one of multiple patterns classified previously; and switching a gamma curve to be applied to the image data, to a gamma curve corresponding to the one of multiple patterns in response to a detection of switching of the one of multiple patterns.

According to an embodiment of the present disclosure, a non-transitory recording medium storing multiple instructions which, when executed by one or more processors, causes the one or more processors to perform a method, includes emitting light; generating an image with the light from the light source; projecting the image generated, to a projection surface; and acquiring image data of the image projected onto the projection surface; classifying a pattern of the image indicated by the image data into one of multiple patterns; detecting whether the one of multiple patterns has been switched from the one of multiple patterns classified previously; and switching a gamma curve to be applied to the image data, to a gamma curve corresponding to the one of multiple patterns in response to a detection of switching of the one of multiple patterns.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a view illustrating an example of a general structure of an image projection apparatus according to an embodiment;

FIG. 2 is a view illustrating an example of a general structure of an illumination device of the image projection apparatus according to the embodiment;

FIG. 3 is a block diagram illustrating an example of a hardware configuration of the image projection apparatus according to the embodiment;

FIG. 4 is a block diagram illustrating an example of configurations of functional blocks of the image projection apparatus according to the embodiment;

FIG. 5 is a graph presenting an example of frequency characteristics of a continuous image;

FIG. 6 is a graph presenting an example of frequency characteristics of a discrete image;

FIG. 7 is a graph presenting an example of gamma curves; and

FIG. 8 is a flowchart presenting an example of a flow of an operation of the image projection apparatus according to the embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

As a technique for dealing with the above-described defocusing, a technique of related art has been disclosed in which a camera captures an image projected on a screen by a projector, detects defocusing, feeds back the detection result to the projector, and controls an electric focus mounted on the projector to stably keep the focusing quality of the image projected on the screen.

However, the technique of related art involves a disadvantage that a projection optical system uses an electric focus mechanism and an imaging device that images a screen surface, and the structure is complicated and the cost is increased accordingly.

With the embodiments of the present disclosure, defocusing can be made less recognizable while the structure is prevented from being complicated.

An image projection apparatus, an image projection method, and a program according to an embodiment of the present disclosure will be described in detail with reference to the drawings. The present disclosure, however, is not limited to the following embodiment, and components of the following embodiment include components that may be easily conceived by those skilled in the art, components being substantially the same, and components being within equivalent ranges. Furthermore, various omissions, substitutions, changes, and combinations of the components can be made without departing from the gist of the following embodiment.

### General Structure of Image Projection Apparatus

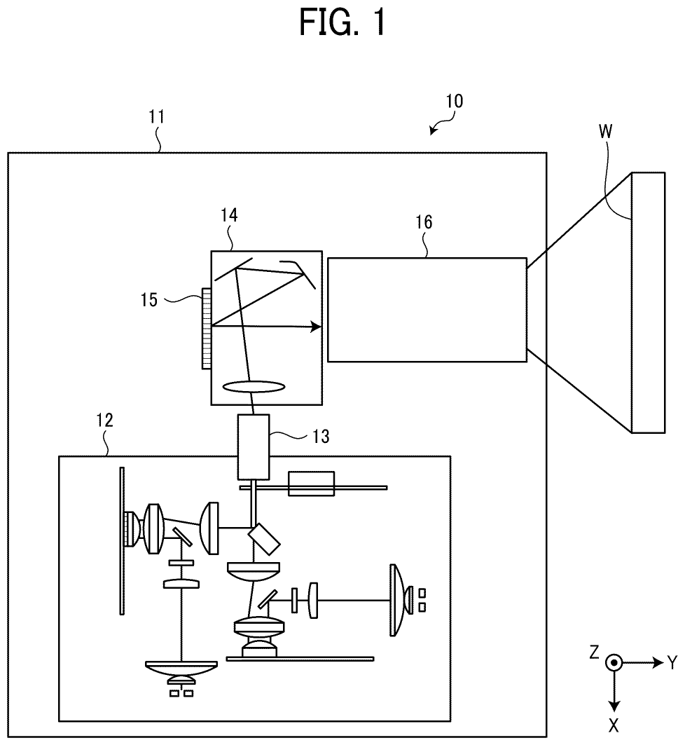

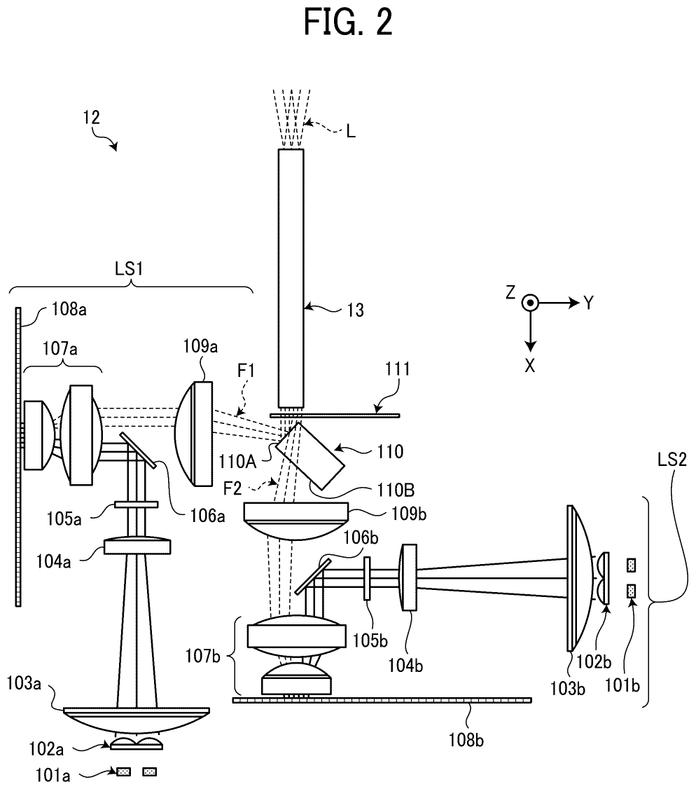

FIG. 1 is a view illustrating an example of a general structure of an image projection apparatus 10 according to an embodiment. FIG. 2 is a view illustrating an example of a general structure of an illumination device 12 of the image projection apparatus 10 according to the embodiment. The overview of the structure of the image projection apparatus 10 according to the embodiment is described with reference to FIGS. 1 and 2. In FIGS. 1 and 2, it is assumed that an X direction, a Y direction, and a Z direction are directions perpendicular to one another, the X direction and the Y direction indicate horizontal directions, and the Z direction indicates a vertical direction.

The image projection apparatus 10 illustrated in FIG. 1 projects an image indicated by image data, such as a moving image or a still image, onto a projection surface W. The image projection apparatus 10 includes, in a housing 11, an illumination device 12 as a light source, a rod integrator 13, an illumination optical system 14, a digital micromirror device (DMD) 15 as an imager, and a projection optical system 16.

The illumination device 12 emits illumination light. The details of the structure of the illumination device 12 will be described later.

The rod integrator 13 is a rod-shaped glass member, and is an optical element that reflects the illumination light incident from the illumination device 12 multiple times to uniformize the illumination light. Specifically, the rod integrator 13 outputs illumination light obtained such that light F1 and light F2 of two systems are combined by a prism 110 (described later) to have uniformized illuminance and light intensity distribution.

The optical element that uniformizes light is not limited to the rod integrator 13, and may use, for example, a prism-shaped light tunnel in which four mirrors are bonded, or a fly eye lens.

The illumination optical system 14 guides the illumination light output from the rod integrator 13 to the DMD 15. The illumination optical system 14 includes optical elements including a lens and a mirror.

The DMD 15 is a member that reflects the illumination light guided by the illumination optical system 14 using a micromirror surface disposed on the front side to generate an image. Alternatively, a transmissive liquid crystal element or a reflective liquid crystal element may be used instead of the DMD 15.

The projection optical system 16 is disposed downstream of the DMD 15 in an optical path and projects light indicating the image generated by the DMD 15 as projection light onto the projection surface W in an enlarged manner. The projection surface W is a screen. The projection optical system 16 includes optical elements including a lens and a mirror.

The details of the structure of the illumination device 12 are described next with reference to FIG. 2. FIG. 2 is a schematic plan view of the image projection apparatus 10 when viewed from above.

As illustrated in FIG. 2, the illumination device 12 includes a first light-source unit LS1, a second light-source unit LS2, a prism 110, and a color wheel 111.

The first light-source unit LS1 emits light F1 to the prism 110. The light F1 is obtained such that a light source emits excitation light and various optical elements in the first light-source unit LS1 apply optical processing on the excitation light. As illustrated in FIG. 2, the first light-source unit LS1 includes a light-emitting diode (LED) light source 101a, a collimator lens 102a, a light source optical system 103a, a condenser element 104a, a microlens array 105a, a dichroic mirror 106a, a first condenser optical system 107a, a fluorescent wheel 108a, and a second condenser optical system 109a.

The LED light source 101a is a light source member that emits excitation light using an LED as a light source. The LED light source 101a is not limited to the LED, and may be, for example, a multichip laser diode unit in which multiple light emitters are one-dimensionally or two-dimensionally arrayed.

The collimator lens 102a is an optical member that is disposed to face the light emission side of the LED light source 101a and that converts the excitation light emitted from the LED light source 101a into parallel light.

The light source optical system 103a is an optical member that focuses the excitation light converted by the collimator lens 102a into the parallel light.

The condenser element 104a is a lens member that is disposed downstream of the light source optical system 103a, that has a negative power, and that reduces the focusing property of the excitation light focused by the light source optical system 103a.

The microlens array 105a is a light profile adjustment element that uniformizes the light intensity distribution of an irradiation spot of the excitation light emitted at a desirable position on the fluorescent wheel 108a located on the downstream side.

The dichroic mirror 106a is a reflecting member that reflects light having a specific wavelength among light beams of the excitation light transmitted through the microlens array 105a. Alternatively, a diffractive optical element (DOE) of reflective type may be used instead of the dichroic mirror 106a.

The first condenser optical system 107a is an optical member that causes the excitation light reflected by the dichroic mirror 106a to form an irradiation spot at a desirable position on the fluorescent wheel 108a. As described later, light reflected by the fluorescent wheel 108a is transmitted through the first condenser optical system 107a again and travels toward the second condenser optical system 109a.

The fluorescent wheel 108a is a disc-shaped wavelength conversion element that is rotated at high speed by a driving motor. The fluorescent wheel 108a has a fluorescent region that is a wavelength conversion region coated with a fluorescent material, and an excitation-light reflecting region that is a wavelength non-conversion region that reflects the excitation light. That is, as the fluorescent wheel 108a rotates, the fluorescent region and the excitation-light reflecting region are switched at the position of the irradiation spot. In the present embodiment, as the excitation light emitted from the LED light source 101a, for example, blue light having a center wavelength of emission intensity of 455 nm can be used. In this case, when the excitation-light reflecting region is located at the position of the irradiation spot, the fluorescent wheel 108a outputs the blue light without converting the wavelength. In contrast, when the fluorescent region is located at the position of the irradiation spot, the fluorescent wheel 108a converts the wavelength of the light into yellow or yellow-green fluorescence and outputs the fluorescence.

While the fluorescent wheel 108a is divided into the two regions of the fluorescent region and the excitation-light reflecting region, this does not imply any limitation. The fluorescent wheel 108a may have multiple fluorescent regions that convert light into light with wavelengths different from each other (for example, a fluorescent region that emits yellow light and a fluorescent region that emits green light), or multiple excitation-light reflecting regions.

The second condenser optical system 109a is an optical member that focuses the light reflected by the fluorescent wheel 108a and transmitted through the first condenser optical system 107a. The light focused by the second condenser optical system 109a is incident on a reflecting surface 110A of the prism 110.

The second light-source unit LS2 emits light F2 to the prism 110. The light F2 is obtained such that a light source emits excitation light and various optical elements in the second light-source unit LS2 apply optical processing on the excitation light. As illustrated in FIG. 2, the second light-source unit LS2 includes a LED light source 101b, a collimator lens 102b, a light source optical system 103b, a condenser element 104b, a microlens array 105b, a dichroic mirror 106b, a first condenser optical system 107b, a fluorescent wheel 108b, and a second condenser optical system 109b. The functions of the LED light source 101b, the collimator lens 102b, the light source optical system 103b, the condenser element 104b, the microlens array 105b, the dichroic mirror 106b, the first condenser optical system 107b, the fluorescent wheel 108b, and the second condenser optical system 109b are respectively similar to the functions of the LED light source 101a, the collimator lens 102a, the light source optical system 103a, the condenser element 104a, the microlens array 105a, the dichroic mirror 106a, the first condenser optical system 107a, the fluorescent wheel 108a, and the second condenser optical system 109a described above. The light focused by the second condenser optical system 109b is incident on a transmitting surface 110B of the prism 110.

The prism 110 is a polyhedron combining optical element having four or more surfaces. The prism 110 reflects the light F1 emitted from the first light-source unit LS1 by the reflecting surface 110A, transmits the light F2 emitted from the second light-source unit LS2 through the transmitting surface 110B, combines the light F1 and the light F2, and guides the combined light to the rod integrator 13 as light beams traveling in substantially the same directions.

In the prism 110, the transmitting surface 110B on which the light F2 is incident desirably serves as a diffusion surface. Since the transmitting surface 110B serves as the diffusion surface, unevenness in color and luminance of the light passing through the transmitting surface 110B can be eliminated or reduced. Alternatively, instead of the diffusion surface of the prism 110, a diffusion plate may be additionally provided to eliminate or reduce unevenness in color and luminance of the light.

The combining optical element is not limited to the prism 110, and may be any optical element that can combine light emitted from two or more light source units into light traveling in substantially the same directions and guide the combined light to the rod integrator 13.

The color wheel 111 is a disc-shaped member that is disposed between the prism 110 and the rod integrator 13 and that time-divides the light combined by the prism 110 into red, blue, green, and yellow light. Specifically, the color wheel 111 has a red region that transmits red light, a blue region that transmits blue light, a green region that transmits green light, and a yellow region that transmits yellow light, and is rotated by a motor to time-divide the light combined by the prism 110 into red, blue, green, and yellow light. The light time-divided by the color wheel 111 is incident on the rod integrator 13.

The rotation of the color wheel 111 is controlled in synchronization with the rotation of the fluorescent wheels 108a and 108b at the same rotation speed as the rotation speed of the fluorescent wheels 108a and 108b. For example, as described above, when the light divided into blue light and yellow (or yellow-green) fluorescence by the fluorescent wheels 108a and 108b is incident on the color wheel 111, the rotation of the color wheel 111 is controlled so that the blue region of the color wheel 111 corresponds to the excitation-light reflecting regions of the fluorescent wheels 108a and 108b and the red region, the green region, and the yellow region of the color wheel 111 correspond to the fluorescent regions of the fluorescent wheels 108a and 108b.

As described above, the red, blue, green, and yellow light time-divided by the fluorescent wheels 108a and 108b and the color wheel 111 are uniformized by the rod integrator 13 and then guided to the DMD 15.

Alternatively, the color wheel 111 may be disposed downstream of the rod integrator 13 (on the light emission side).

### Hardware Configuration of Image Projection Apparatus

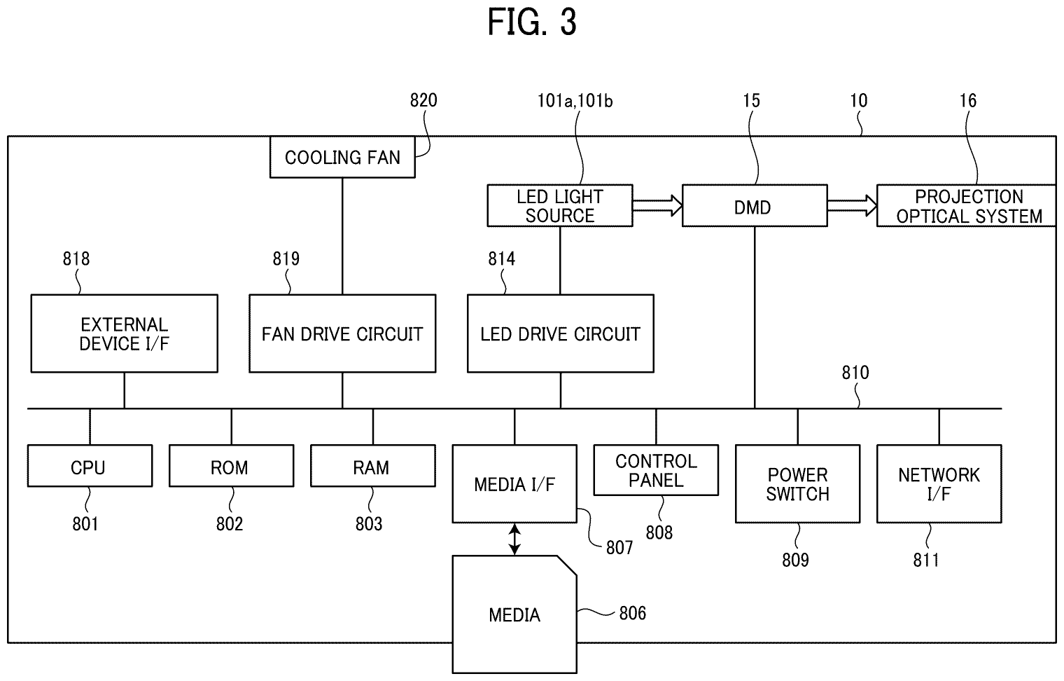

FIG. 3 is a block diagram illustrating an example of a hardware configuration of the image projection apparatus 10 according to the embodiment. The hardware configuration of the image projection apparatus 10 according to the embodiment will be described with reference to FIG. 3.

As illustrated in FIG. 3, the image projection apparatus 10 includes a central processing unit (CPU) 801, a read-only memory (ROM) 802, a random-access memory (RAM) 803, a media interface (I/F) 807, a control panel 808, a power switch 809, a network interface I/F 811, an LED drive circuit 814, an external device I/F 818, a fan drive circuit 819, and a cooling fan 820. The CPU 801, the ROM 802, the RAM 803, the media I/F 807, the control panel 808, the network I/F 811, the LED drive circuit 814, the external device I/F 818, and the fan drive circuit 819 are electrically connected to one another via a bus 810, which may be an address bus or a data bus, so that data can be transmitted and received among the components.

The CPU 801 is an arithmetic device that controls the entire operation of the image projection apparatus 10. The ROM 802 is a non-volatile storage device that stores a program used for driving the CPU 801.

The RAM 803 is a volatile storage device that is used as a work area of the CPU 801.

The media I/F 807 is an interface circuit that controls reading or writing (storing) of data from or to a media 806 such as a flash memory.

The control panel 808 includes, for example, various keys, buttons, and LEDs, and is used for a user to perform various operations other than turning on or off the power of the image projection apparatus 10. For example, the control panel 808 receives an instruction operation, such as an operation of adjusting the size of a projection image, an operation of adjusting the color tone, a focus adjustment operation, or a keystone adjustment operation, and outputs the received operation content to the CPU 801.

The power switch 809 is for switching the power of the image projection apparatus between on and off.

The network I/F 811 is an interface circuit for performing transmission and reception of data through a communication network such as the Internet.

The LED drive circuit 814 controls turning on and off of the LED light sources 101a and 101b under the control of the CPU 801.

The external device I/F 818 is an interface circuit that is connected to an external device such as a personal computer (PC) to transmit and receive, for example, control signals and image data.

The fan drive circuit 819 is connected to the CPU 801 and the cooling fan 820, to drive or stop driving the cooling fan 820 based on a control signal from the CPU 801. The cooling fan 820 is a fan device that is rotated by the fan drive circuit 819 to exhaust the air inside the image projection apparatus 10 and cool the inside of the image projection apparatus 10.

When power is supplied from the power supply, the CPU 801 is activated in accordance with a control program stored in the ROM 802 in advance, and gives a control signal to the LED drive circuit 814 to turn on the LED light sources 101a and 101b. The CPU 801 gives a control signal to the fan drive circuit 819 to rotate the cooling fan 820 at a predetermined rated rotation speed. When the supply of power from the power circuit is started in the image projection apparatus 10, the DMD 15 is brought into a state available for displaying an image, and further power is supplied from the power circuit to various other components.

In the image projection apparatus 10, when the power switch 809 is turned off, a power off signal is transmitted from the power switch 809 to the CPU 801. When the CPU 801 detects the power off signal, the CPU 801 gives a control signal to the LED drive circuit 814 to turn off the LED light sources 101a and 101b. Then, when a predetermined time elapses, the CPU 801 gives a control signal to the fan drive circuit 819 to stop the cooling fan 820, ends the control process of the CPU 801, and finally gives an instruction to the power circuit to stop the supply of power.

### Configurations and Operations of Functional Blocks of Image Projection Apparatus

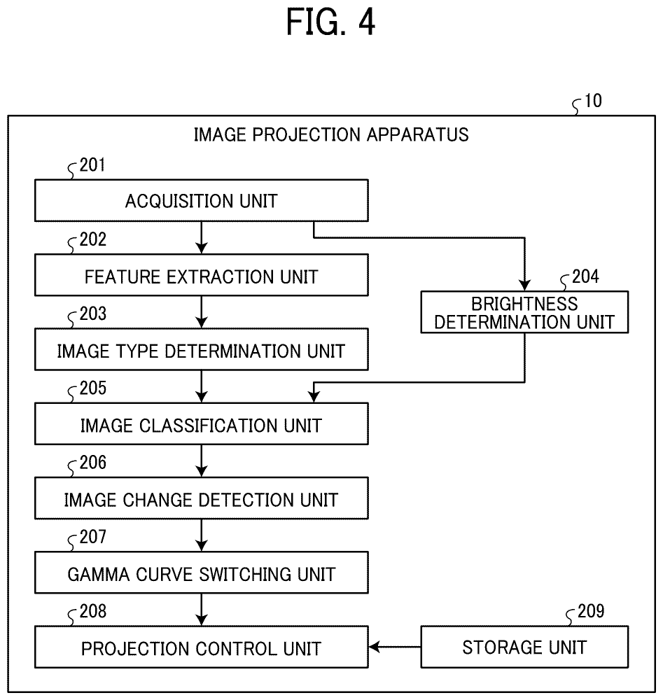

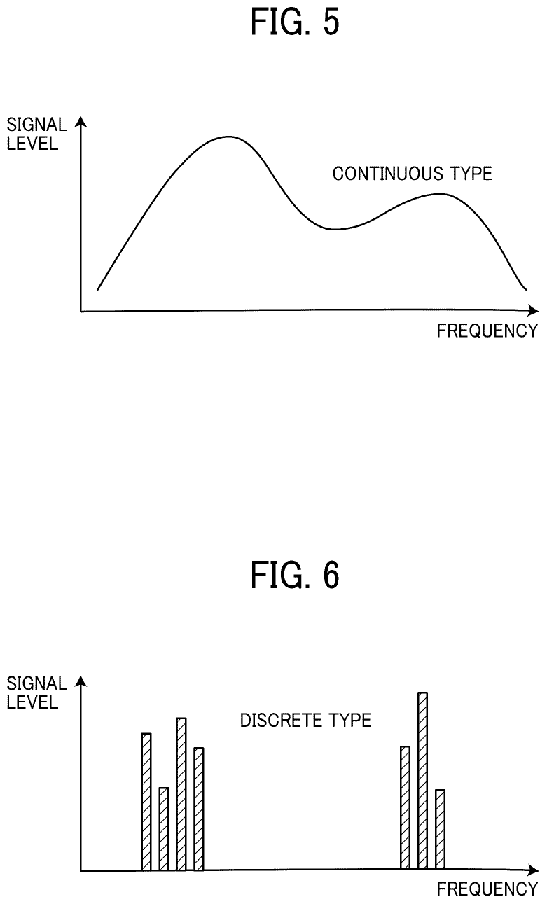

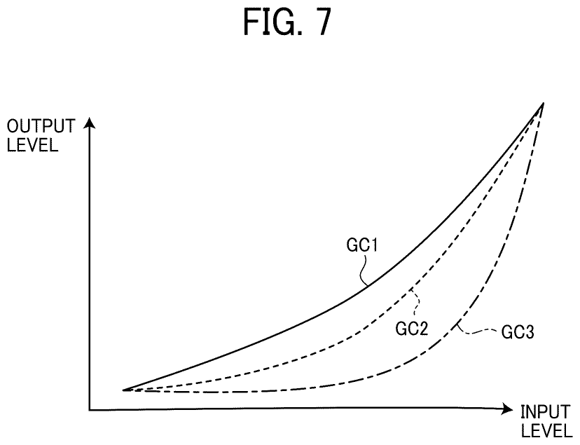

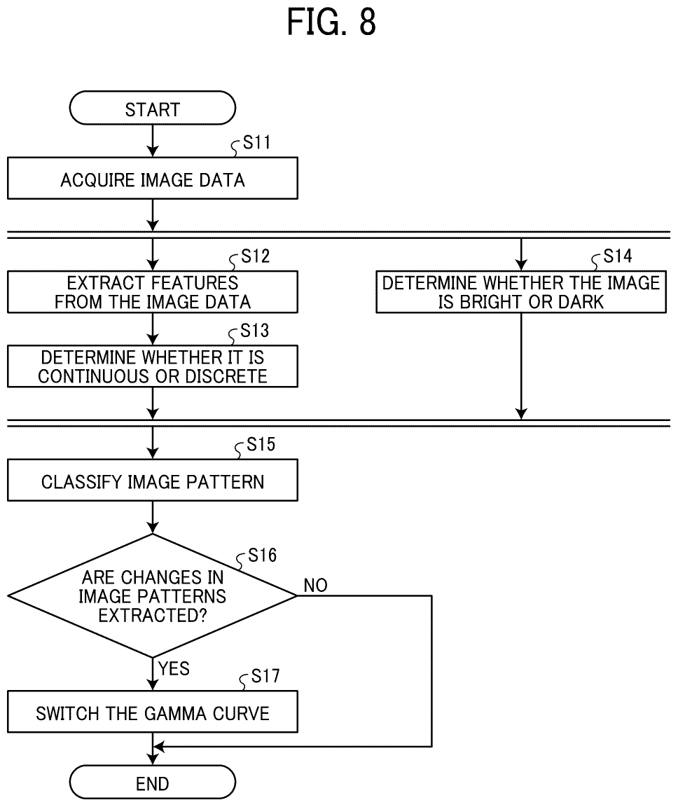

FIG. 4 is a block diagram illustrating an example of configurations of functional blocks of the image projection apparatus 10 according to the embodiment. FIG. 5 is a graph presenting an example of frequency characteristics of a continuous image. FIG. 6 is a graph presenting an example of frequency characteristics of a discrete image. FIG. 7 is a graph presenting an example of gamma curves. The configurations and operations of the functional blocks of the image projection apparatus 10 according to the embodiment will be described with reference to FIGS. 4 to 7.

As illustrated in FIG. 4, the image projection apparatus 10 includes an acquisition unit 201, a feature extraction unit 202 (extraction unit), an image type determination unit 203 (first determination unit), a brightness determination unit 204 (second determination unit), an image classification unit 205 (classification unit), an image change detection unit 206 (detection unit), a gamma curve switching unit 207 (switching unit), a projection control unit 208, and a storage unit 209 that is implemented by a memory.

The acquisition unit 201 is a functional unit that acquires image data via the media I/F 807, the external device I/F 818, or the network I/F 811.

The feature extraction unit 202 is a functional unit that decomposes signal levels of brightness values of the image data acquired by the acquisition unit 201 into frequency components through, for example, frequency analysis on the image data and extracts the frequency components as features. For example, when the image data acquired by the acquisition unit 201 is moving image data, the feature extraction unit 202 cumulatively performs frequency analysis for several frames and extracts decomposed frequency components as features.

As illustrated in FIG. 5, when the frequency components of the signal levels of the image data are entirely included over a wide range of frequencies, it is determined that the image is a natural image or the like, and the image indicated by such image data is referred to as a continuous image. In contrast, as illustrated in FIG. 6, when the frequency components of the signal levels of the image data are discretely distributed, it is determined that the image is a presentation material or the like including a large amount of text, and the image indicated by such image data is referred to as a discrete image.

The image type determination unit 203 is a functional unit that determines whether the type of the image indicated by the image data is a continuous image (first image) or a discrete image (second image) based on the frequency components of the image data extracted by the feature extraction unit 202. For example, the image type determination unit 203 may determine that the image indicated by the image data is a continuous image when frequency components of signal levels equal to or more than a predetermined threshold exist over a predetermined frequency range, and may determine that the image indicated by the image data is a discrete image when the frequency components do not exist over the predetermined frequency range. The method of determining whether the image is a continuous image or a discrete image is not limited to the above-described method.

The brightness determination unit 204 is a functional unit that determines whether the image indicated by the image data acquired by the acquisition unit 201 is a bright image (third image) or a dark image (fourth image). For example, the brightness determination unit 204 may calculate an average picture level (APL) of the image indicated by the image data. When the APL is equal to or more than a predetermined threshold, the brightness determination unit 204 may determine that the image is a bright image. When the APL is less than the predetermined threshold, the brightness determination unit 204 may determine that the image is a dark image. The method of determining whether the image is a bright image or a dark image is not limited to the above-described method.

The image classification unit 205 is a functional unit that classifies the pattern of the image indicated by the image data acquired by the acquisition unit 201 based on the determination results of the image type determination unit 203 and the brightness determination unit 204. Specifically, the image classification unit 205 classifies the image into one of four patterns of a continuous image and a bright image, a continuous image and a dark image, a discrete image and a bright image, and a discrete image and a dark image.

The patterns of images classified by the image classification unit 205 are not limited to the above-described four patterns, and images may be classified into patterns other than the four patterns. For example, the image type determination unit 203 does not have to determine the image as one of a continuous image and a discrete image, and may determine the image as one of images of three or more types based on the frequency components of the image data. The brightness determination unit 204 does not have to determine the image as one of a bright image and a dark image, and may determine the image as one of images having three or more levels of brightness based on, for example, the above-described APL of the image data.

Consequently, the image classification unit 205 may classify the image as one of four or more patterns.

The image classification unit 205 does not have to classify the pattern of the image indicated by the image data based on the determination results of both the image type determination unit 203 and the brightness determination unit 204, and may classify the pattern based on the determination result of at least one of the image type determination unit 203 and the brightness determination unit 204.

The image change detection unit 206 is a functional unit that detects whether the pattern of the image classified by the image classification unit 205 has been switched to a pattern different from the pattern of the image classified by the image classification unit 205 immediately before.

The gamma curve switching unit 207 is a functional unit that switches a gamma curve to be applied to the image data when the image change detection unit 206 detects that the pattern of the image of the image data has been switched to another pattern. Switching the gamma curve to be applied to the image data represents, for example, when the image data is moving image data and when the pattern of an image of a specific frame (or a frame group) included in the moving image data is switched to a different pattern as the pattern of an image of a frame (or a frame group) subsequent to the specific frame, switching from a gamma curve applied to the specific frame to a gamma curve corresponding to the subsequent frame.

The gamma curve controls the relationship between the input level and the output level of image data to determine the brightness of an intermediate brightness level so that a displayed image (in this case, an image projected by the image projection apparatus 10) seems to change from black to white (or from white to black) in a predetermined manner. For example, a gamma curve that controls the relationship between the input level and the output level of image data so that the image seems to change from black to white by a certain amount of change (that is, linearly) when the image of the image data is displayed is a gamma curve optimal for the image projection apparatus 10 serving as a display device, and is expressed by, for example, a gamma curve GC2 presented in FIG. 7. In contrast, a gamma curve that controls the relationship between the input level and the output level of image data to give a bright impression as the whole image by displaying the intermediate brightness level higher than the gamma curve GC2 is expressed by, for example, a gamma curve GC1 presented in FIG. 7. A gamma curve that controls the relationship between the input level and the output level of image data to give a dark impression as the whole image by displaying the intermediate brightness level lower than the gamma curve GC2 is expressed by, for example, a gamma curve GC3 presented in FIG. 7. That is, the gamma data to be applied to the image data is switched, and hence the displaying form of the image of the image data can be changed. As presented in FIG. 7, the brightness levels (brightnesses) of black and white do not change in any gamma curve, and the intermediate brightness level is changed. In the present embodiment, it assumed that the data of the gamma curves GC1 to GC3 are stored in the storage unit 209.

In a continuous image such as a natural image, various frequency components are mixed in the image, and hence it is determined that defocusing is less likely to be recognized. Thus, the gamma curve switching unit 207 performs switching to apply the gamma curve GC2 optimal for the display device to the image data when the image change detection unit 206 detects that the pattern of the image of the image data has been switched to the pattern of a continuous image.

In contrast, a discrete image such as a presentation material often displays a character string, characters are expected to be read, and hence it is determined that defocusing is highly likely to be recognized. Since the drift of the lens of the projection optical system 16 depends on the intensity of transmitted light (that is, the brightness of the image), the drift is to be noticeable when the intensity of light rapidly changes. Since occurrence of the drift is unavoidable, in the present embodiment, the elapsed time during which the drift appears is controlled to make the defocusing less recognizable. Specifically, the gamma curve switching unit 207 performs switching to apply the gamma curve GC1 that displays the intermediate brightness level higher than the gamma curve GC2 to the image data when the image change detection unit 206 detects that the pattern of the image of the image data has been switched to the pattern of a discrete image and a dark image. The gamma curve switching unit 207 performs switching to apply the gamma curve GC3 that displays the intermediate brightness level lower than the gamma curve GC2 to the image data when the image change detection unit 206 detects that the pattern of the image of the image data has been switched to the pattern of a discrete image and a bright image. Thus, the rapid change in brightness of the image can be smoothed, occurrence of the drift can be also smoothed, and the defocusing can be less recognizable.

The operation of the gamma curve switching unit 207 is not limited to switching the gamma curve from one of the three types of gamma curves GC1 to GC3 to another one of the gamma curves GC1 to GC3, and may switch the gamma curve from one of four or more types of gamma curves to another one of the four or more types of gamma curves in accordance with the pattern of the image detected by the image change detection unit 206.

The projection control unit 208 is a functional unit that applies the gamma curve switched by the gamma curve switching unit 207 to the image data acquired by the acquisition unit 201, controls the DMD 15 to generate an image, and projects the image from the projection optical system 16. Specifically, the projection control unit 208 may refer to the storage unit 209, read the data of the gamma curve switched by the gamma curve switching unit 207, and apply the gamma curve to the image data.

The storage unit 209 is a functional unit that stores, for example, the data of the gamma curves and the image data acquired by the acquisition unit 201. The storage unit 209 is implemented by the ROM 802 or the RAM 803 illustrated in FIG. 3.

The acquisition unit 201, the feature extraction unit 202, the image type determination unit 203, the brightness determination unit 204, the image classification unit 205, the image change detection unit 206, the gamma curve switching unit 207, and the projection control unit 208 described above are implemented by, for example, the CPU 801 illustrated in FIG. 3 executing a program. At least a portion of the acquisition unit 201, the feature extraction unit 202, the image type determination unit 203, the brightness determination unit 204, the image classification unit 205, the image change detection unit 206, the gamma curve switching unit 207, and the projection control unit 208 may be implemented by a hardware circuit such as a field-programmable gate array (FPGA) or an application specific integrated circuit (ASIC).

Each functional unit of the image projection apparatus 10 illustrated in FIG. 4 conceptually indicates a function, and is not limited to such a configuration. That is, the functional units of the image projection apparatus 10 do not have to be implemented by software modules distinct as the blocks illustrated in FIG. 4. The functions of the functional units as a whole may be implemented by the image projection apparatus 10 executing a program. For example, multiple functional units illustrated as independent functional units in the image projection apparatus 10 illustrated in FIG. 4 may serve as one functional unit. In contrast, the function of one functional unit in the image projection apparatus 10 illustrated in FIG. 4 may be divided into multiple functions to serve as multiple functional units.

### General Operation of Image Projection Apparatus

FIG. 8 is a flowchart presenting an example of a flow of an operation of the image projection apparatus 10 according to the embodiment. The flow of the general operation of the image projection apparatus 10 according to the embodiment is described with reference to FIG. 8.

### Step S11

The acquisition unit 201 of the image projection apparatus 10 acquires image data via the media I/F 807, the external device I/F 818, or the network I/F 811. The operation then proceeds to step S12 and step S14.

### Step S12

The feature extraction unit 202 of the image projection apparatus 10 decomposes signal levels of brightness values of the image data acquired by the acquisition unit 201 into frequency components through, for example, frequency analysis on the image data and extracts the frequency components as features. The operation then proceeds to step S13.

### Step S13

The image type determination unit 203 of the image projection apparatus 10 determines whether the image indicated by the image data is a continuous image or a discrete image based on the frequency components of the image data extracted by the feature extraction unit 202.

### Step S14

The brightness determination unit 204 of the image projection apparatus 10 determines whether the image indicated by the image data acquired by the acquisition unit 201 is a bright image or a dark image.

When the processes in steps S13 and S14 described above are ended, the operation proceeds to step S15.

### Step S15

The image classification unit 205 of the image projection apparatus 10 classifies the image indicated by the image data acquired by the acquisition unit 201 based on the determination results of the image type determination unit 203 and the brightness determination unit 204.

Specifically, the image classification unit 205 classifies the image into one of four patterns of a continuous image and a bright image, a continuous image and a dark image, a discrete image and a bright image, and a discrete image and a dark image. The operation then proceeds to step S16.

### Step S16

The image change detection unit 206 of the image projection apparatus 10 detects whether the pattern of the image classified by the image classification unit 205 has been switched to a pattern different from the pattern of the image classified by the image classification unit 205 immediately before. When the image change detection unit 206 detects a change (switching) of the pattern of the image (step S16: Yes), the operation proceeds to step S17. When the image change detection unit 206 does not detect a change (switching) of the pattern of the image (step S16: No), the operation is ended.

### Step S17

The gamma curve switching unit 207 of the image projection apparatus 10 performs switching to apply a gamma curve corresponding to the pattern of the image, the switching of which is detected by the image change detection unit 206, to the image data acquired by the acquisition unit 201. Specifically, the gamma curve switching unit 207 performs switching to apply the gamma curve GC2 optimal for the display device to the image data when the image change detection unit 206 detects that the pattern of the image of the image data has been switched to the pattern of a continuous image. The gamma curve switching unit 207 performs switching to apply the gamma curve GC1 that displays the intermediate brightness level higher than the gamma curve GC2 to the image data when the image change detection unit 206 detects that the pattern of the image of the image data has been switched to the pattern of a discrete image and a dark image.

The gamma curve switching unit 207 performs switching to apply the gamma curve GC3 that displays the intermediate brightness level lower than the gamma curve GC2 to the image data when the image change detection unit 206 detects that the pattern of the image of the image data has been switched to the pattern of a discrete image and a bright image. The projection control unit 208 of the image projection apparatus 10 applies the gamma curve switched by the gamma curve switching unit 207 to the image data acquired by the acquisition unit 201, controls the DMD 15 to generate an image, and projects the image from the projection optical system 16. The operation is then ended.

Steps S11 to S17 described above are repeatedly executed. When the entirety of the image data is acquired by the acquisition unit 201 in step S11 and the acquired image is stored in the storage unit 209, steps S12 to S17 may be repeatedly executed with reference to the image data stored in the storage unit 209.

As described above, in the image projection apparatus 10 according to the present embodiment, the acquisition unit 201 acquires image data, the image classification unit 205 classifies a pattern of an image indicated by the image data acquired by the acquisition unit 201, the image change detection unit 206 detects whether the pattern classified by the image classification unit 205 has been switched, and the gamma curve switching unit 207 switches a gamma curve to be applied to the image data to a gamma curve corresponding to the pattern when the image change detection unit 206 detects that the pattern has been switched. Thus, an additional structure or device, such as a focus mechanism or an imaging device, does not have to be mounted to deal with defocusing, thereby preventing the structure from being complicated and making defocusing less recognizable.

In the above-described embodiment, when at least one of the functional units of the image projection apparatus 10 is implemented by execution of a program, the program is provided by being incorporated in advance in a ROM or the like. The program to be executed in the image projection apparatus 10 according to the above-described embodiment may be provided by being recorded in a computer-readable storage medium such as a compact disc read-only memory (CD-ROM), a flexible disk (FD), a compact disc-recordable (CD-R), or a digital versatile disc (DVD) in a file of an installable format or an executable format. The program to be executed in the image projection apparatus 10 according to the above-described embodiment may be stored in a computer connected to a network such as the Internet and provided by being downloaded via the network. The program to be executed in the image projection apparatus 10 according to the above-described embodiment may be provided or distributed via a network such as the Internet. The program to be executed in the image projection apparatus 10 according to the above-described embodiment has a module configuration including at least one of the above-described functional units. As actual hardware, the CPU 801 reads the program from the above-described storage device (for example, the ROM 802 or the media 806) and executes the program, and hence the above-described functional units are loaded onto the main storage device (the RAM 803) and generated.

Aspects of the present disclosure are as follows.

### Aspect 1

According to Aspect 1, an image projection apparatus that projects an image from a projection optical system includes an acquisition unit to acquire image data; a classification unit to classify a pattern of an image indicated by the image data acquired by the acquisition unit; a detection unit to detect whether the pattern classified by the classification unit has been switched; and a switching unit to switch a gamma curve to be applied to the image data to a gamma curve corresponding to the pattern when the detection unit detects that the pattern has been switched.

### Aspect 2

According to Aspect 2, the image projection apparatus of Aspect 1 further includes a projection control unit to apply the gamma curve switched by the switching unit to the image data to project an image from the projection optical system.

### Aspect 3

According to Aspect 3, the image projection apparatus of Aspect 2 further includes a storage unit to store data of the gamma curve, the gamma curve including multiple gamma curves. The projection control unit reads the data corresponding to the gamma curve switched by the switching unit from the storage unit and applies the gamma curve to the image data.

### Aspect 4

According to Aspect 4, the image projection apparatus of any one of Aspect 1 to Aspect 3 further includes an extraction unit to extract predetermined features for the image data acquired by the acquisition unit; and a first determination unit to determine a type of the image indicated by the image data based on the features extracted by the extraction unit. The classification unit classifies the pattern of the image indicated by the image data based on at least a determination result of the first determination unit.

### Aspect 5

According to Aspect 5, in the image projection apparatus of Aspect 4, the extraction unit decomposes brightness values of the image data acquired by the acquisition unit into frequency components and extracts the frequency components as the features. The first determination unit determines whether the image indicated by the image data includes at least one of a first image in which the frequency components continuously exist in a predetermined frequency range or a second image in which the frequency components discretely exist based on the frequency components extracted by the extraction unit.

### Aspect 6

According to Aspect 6, the image projection apparatus of any one of Aspect 1 to Aspect 5 further includes a second determination unit to determine whether the image indicated by the image data acquired by the acquisition unit includes at least one of a third image having a predetermined brightness or more or a fourth image darker than the third image. The classification unit classifies the pattern of the image indicated by the image data based on at least a determination result of the second determination unit.

### Aspect 7

According to Aspect 7, an image projection method of projecting an image from a projection optical system includes acquiring image data; classifying a pattern of an image indicated by the acquired image data; detecting whether the classified pattern has been switched; and switching a gamma curve to be applied to the image data to a gamma curve corresponding to the pattern when it is determined that the pattern has been switched.

### Aspect 8

According to Aspect 8, a non-transitory recording medium storing multiple instructions which, when executed by one or more processors, causes the one or more processors to perform a method includes acquiring image data; classifying a pattern of an image indicated by the acquired image data; detecting whether the classified pattern has been switched; and switching a gamma curve to be applied to the image data to a gamma curve corresponding to the pattern when it is determined that the pattern has been switched.

### Aspect 9

An image projection apparatus includes a light source to emit light; an imager to generate an image with the light from the light source; a projection optical system to project the image generated by the imager to a projection surface; and circuitry. The circuitry is configured to: acquire image data of the image projected onto the projection surface; classify a pattern of the image indicated by the image data into one of multiple patterns; detect whether the one of multiple patterns has been switched from the one of multiple patterns classified previously; and switch a gamma curve to be applied to the image data, to a gamma curve corresponding to the one of multiple patterns in response to a detection of switching of the one of multiple patterns.

### Aspect 10

In the image projection apparatus according to Aspect 9, the circuitry is further configured to: apply the gamma curve switched, to the image data; control the imager to generate an image based on the image data to which the switched gamma curve has been applied; and the projection optical system projects the image generated by the imager.

### Aspect 11

The image projection apparatus according to Aspect 10 further includes a memory to store data of multiple gamma curves including the gamma curve. The circuitry is further configured to: read the image data corresponding to the gamma curve switched, from the memory; and apply the gamma curve switched, to the image data.

### Aspect 12

In the image projection apparatus according to Aspect 9, the circuitry is further configured to: extract predetermined features for the image data acquired; determine a type of the image indicated by the image data based on the features extracted; and classify the pattern of the image indicated by the image data into one of multiple patterns, at least based on the determined type of the image.

### Aspect 13

In the image projection apparatus according to Aspect 12, the circuitry is further configured to: decompose brightness values of the image data acquired, into frequency components; extract the frequency components as the features, and determine whether the image, indicated by the image data acquired, includes at least one of a first image in which the frequency components continuously exist in a predetermined frequency range or a second image in which the frequency components discretely exist based on the frequency components extracted.

### Aspect 14

In the image projection apparatus according to Aspect 9, the circuitry is further configured to: determine whether the image indicated by the image data acquired includes at least one of: a third image having a predetermined brightness or more; or a fourth image darker than the third image; and classify the pattern of the image indicated by the image data into one of multiple patterns, based on at least a determination result.

### Aspect 15

An image projection method for projecting an image from a projection optical system includes: emitting light; generating an image with the light from the light source; projecting the image generated, to a projection surface; and acquiring image data of the image projected onto the projection surface; classifying a pattern of the image indicated by the image data into one of multiple patterns; detecting whether the one of multiple patterns has been switched from the one of multiple patterns classified previously; and switching a gamma curve to be applied to the image data, to a gamma curve corresponding to the one of multiple patterns in response to a detection of switching of the one of multiple patterns.

### Aspect 16

A non-transitory recording medium storing multiple instructions which, when executed by one or more processors, causes the one or more processors to perform a method, includes: emitting light; generating an image with the light from the light source; projecting the image generated, to a projection surface; and acquiring image data of the image projected onto the projection surface; classifying a pattern of the image indicated by the image data into one of multiple patterns; detecting whether the one of multiple patterns has been switched from the one of multiple patterns classified previously; and switching a gamma curve to be applied to the image data, to a gamma curve corresponding to the one of multiple patterns in response to a detection of switching of the one of multiple patterns.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image projection apparatus comprising:
a light source to emit light;
an imager to generate an image with the light from the light source;
a projection optical system to project the image generated by the imager to a projection surface; and
circuitry configured to:
acquire image data of the image projected onto the projection surface;
classify a pattern of the image indicated by the image data into one of multiple patterns;
detect whether the one of multiple patterns has been switched from the one of multiple patterns classified previously; and
switch a gamma curve to be applied to the image data, to a gamma curve corresponding to the one of multiple patterns in response to a detection of switching of the one of multiple patterns.

2. The image projection apparatus according to claim 1,
wherein the circuitry is further configured to:
apply the gamma curve switched, to the image data;
control the imager to generate an image based on the image data to which the switched gamma curve has been applied; and
the projection optical system projects the image generated by the imager.

3. The image projection apparatus according to claim 2 further comprising a memory to store data of multiple gamma curves including the gamma curve,
wherein the circuitry is further configured to:
read the image data corresponding to the gamma curve switched, from the memory; and
apply the gamma curve switched, to the image data.

4. The image projection apparatus according to claim 1,
wherein the circuitry is further configured to:
extract predetermined features for the image data acquired;
determine a type of the image indicated by the image data based on the features extracted; and
classify the pattern of the image indicated by the image data into one of multiple patterns, at least based on the determined type of the image.

5. The image projection apparatus according to claim 4,
wherein the circuitry is further configured to:
decompose brightness values of the image data acquired, into frequency components;
extract the frequency components as the features, and
determine whether the image, indicated by the image data acquired, includes at least one of a first image in which the frequency components continuously exist in a predetermined frequency range or a second image in which the frequency components discretely exist based on the frequency components extracted.

6. The image projection apparatus according to claim 1,
wherein the circuitry is further configured to:
determine whether the image indicated by the image data acquired includes at least one of:
a third image having a predetermined brightness or more; or
a fourth image darker than the third image; and
classify the pattern of the image indicated by the image data into one of multiple patterns, based on at least a determination result.

7. An image projection method for projecting an image from a projection optical system, the method comprising:
emitting light;
generating an image with the light emitted;
projecting the image generated, to a projection surface; and
acquiring image data of the image projected onto the projection surface;
classifying a pattern of the image indicated by the image data into one of multiple patterns;
detecting whether the one of multiple patterns has been switched from the one of multiple patterns classified previously; and
switching a gamma curve to be applied to the image data, to a gamma curve corresponding to the one of multiple patterns in response to a detection of switching of the one of multiple patterns.

8. A non-transitory recording medium storing multiple instructions which, when executed by one or more processors, causes the one or more processors to perform a method, comprising:
emitting light;
generating an image with the light emitted;
projecting the image generated, to a projection surface; and
acquiring image data of the image projected onto the projection surface;
classifying a pattern of the image indicated by the image data into one of multiple patterns;
detecting whether the one of multiple patterns has been switched from the one of multiple patterns classified previously; and
switching a gamma curve to be applied to the image data, to a gamma curve corresponding to the one of multiple patterns in response to a detection of switching of the one of multiple patterns.
